(19) United States
(12) Patent Application Publication
(10) Pub. No.: US 2024/0177084 A1
(43) Pub. Date: May 30, 2024

(54) KNOWLEDGE MANAGEMENT SYSTEMS AND METHODS

(71) Applicant: Sugarwork, Inc., New York, NY (US)

(72) Inventors: Vanessa Wun-Siu Liu, New York, NY (US); Judith Michelle Williams, San Francisco, CA (US); Adeesha Indukantha Bandara Ekanayake-Weber, New Haven, CT (US); Olivia Grace Listokin, West New York, NJ (US)

(21) Appl. No.: 18/478,926

(22) Filed: Sep. 29, 2023

Related U.S. Application Data
(60) Provisional application No. 63/377,964, filed on Sep. 30, 2022.

(51) Int. Cl. G06Q 10/0631; G06Q 10/1093

(52) U.S. Cl. CPC G06Q 10/063112; G06Q 10/063114; G06Q 10/1095

(57) ABSTRACT

Example knowledge management systems and methods are described. In one implementation, a knowledge transfer plan is identified for transferring knowledge from a first person to a second person, where the knowledge transfer plan is associated with a topic. A meeting is identified between the first person and the second person to transfer knowledge therebetween. The knowledge management systems and methods generate a summary of the meeting and access data from an external source that is related to the topic of the knowledge transfer plan. The summary of the meeting and the data from an external source are aggregated into the knowledge transfer plan.

### RELATED APPLICATIONS

This application claims the priority benefit of U.S. Provisional Application Ser. No. 63/377,964, entitled “Work Management Systems and Methods,” filed on Sep. 30, 2022, the disclosure of which is hereby incorporated by reference herein in its entirety.

### TECHNICAL FIELD

The present disclosure relates to various systems and methods that support the management of knowledge, such as the transfer of knowledge and information between users.

### BACKGROUND

Many company employees have significant knowledge related to their role in the company, such as knowledge related to their work activities, best practices, standard operating procedures, and the like. This knowledge may be acquired over a number of years while working for the company. When an employee leaves the company, much of this critical knowledge and experience may leave with them.

Studies have indicated that companies incur a significant cost when losing an experienced employee. This is common in companies without a system for transferring knowledge from one employee to another.

Knowledge transfer is also important to train new employees, mentor existing employees, and train existing employees for new roles in the company. In many situations, this knowledge transfer is informal without any structured plan for effectively transferring knowledge between two or more employees.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a knowledge management platform.

FIG. 3 is a flow diagram illustrating an embodiment of a method for setting up a knowledge transfer plan.

FIG. 4 is a flow diagram illustrating an embodiment of a method for monitoring implementation of a knowledge transfer plan.

FIG. 5 is a flow diagram illustrating an embodiment of a method for recording, transcribing, and summarizing meetings associated with a knowledge transfer plan.

FIG. 6 is a flow diagram illustrating an embodiment of a method for identifying and retrieving data from multiple sources associated with a knowledge transfer plan.

FIG. 7 illustrates an example knowledge transfer plan.

FIG. 8 illustrates an example representation of the current status of a knowledge transfer plan.

FIG. 9 illustrates an example template associated with a knowledge transfer plan.

FIG. 10 is a block diagram illustrating an embodiment of a network architecture.

FIG. 11 is a flow diagram illustrating an embodiment of a method for generating an LLM request.

FIG. 12 is a flow diagram illustrating an embodiment of a method for summarizing multiple meeting transcripts.

FIG. 13 illustrates an example block diagram of a computing device.

### DETAILED DESCRIPTION

The knowledge management systems and methods discussed herein provide a framework of processes, architecture, software, and hardware to support the transfer of knowledge between two or more employees in an organization. For example, an experienced salesperson may share their sales techniques and other knowledge with younger, less experienced employees. The knowledge management systems and methods described herein assist with the planning, execution, and capture of knowledge.

As described herein, various systems and methods may aggregate different types of data from different data sources and perform unique analysis of employee roles, experiences, activities, and the like. This analysis and aggregation of data may be used to train a particular employee for a new role, a new activity, a part-time role, a new combination of roles, and the like. The analysis and aggregation of data may also support the systems and methods in scheduling the transfer of knowledge between employees in a thorough and organized manner. Additionally, the analysis and aggregation of data may support the coordination, scheduling, and tracking of the transfer of knowledge between employees. Many of these activities can be automated using artificial intelligence and other systems to easily handle significant numbers of employees and perform many tasks previously performed exclusively by human users.

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, smartphones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

At least some embodiments of the disclosure are directed to computer program products comprising such logic (e.g., in the form of software) stored on any computer useable medium. Such software, when executed in one or more data processing devices, causes a device to operate as described herein.

The systems and methods discussed herein help employees share their knowledge and experience with other employees. This transfer of knowledge allows companies to maintain that knowledge if an employee leaves or is laid off. These systems and methods are also valuable tools for training new employees or existing employees who are moving into a new role in the organization.

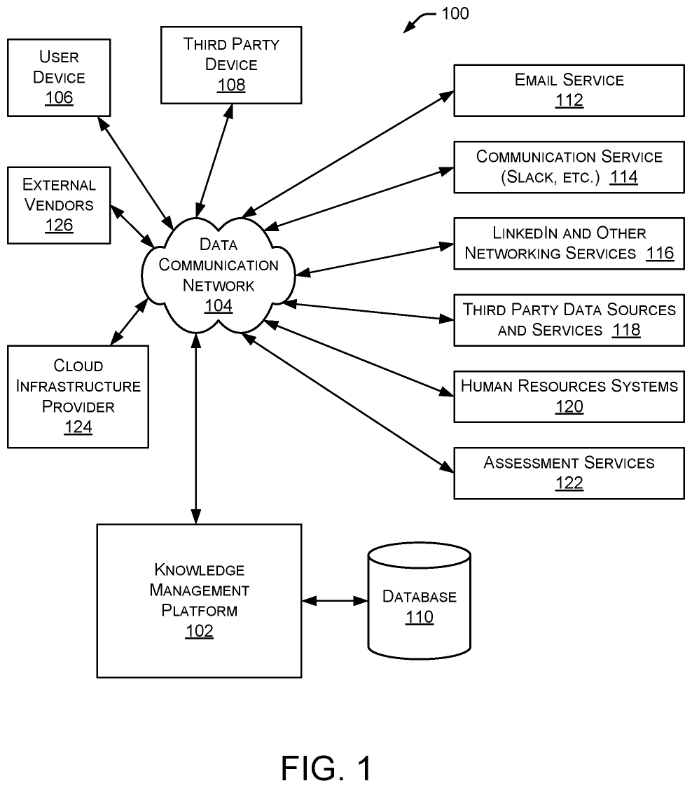

FIG. 1 is a block diagram illustrating an environment 100 within which an example embodiment may be implemented. As shown in FIG. 1, a knowledge management platform 102 is coupled to a data communication network 104 and a database 110. Database 110 may store any type of data, such as data created or used by knowledge management platform 102. Environment 100 also includes a user device 106 and a third party device 108 that can communicate with knowledge management platform 102 via data communication network 104. The interaction between user device 106, third party device 108, and knowledge management platform 102 is discussed in greater detail herein. In some embodiments, user device 106 is any device, such as a computing device, that can communicate with knowledge management platform 102. For example, user device 106 may be used by a person engaged with knowledge management platform 102 to accomplish various tasks and functions, as discussed herein.

In some embodiments, other services and systems may interact with knowledge management platform 102. For example, an email service 112, a communication service 114, and LinkedIn and other networking services 116 may interact with knowledge management platform 102 in the manner discussed herein. Further, third party data sources and services 118, human resources systems 120, and assessment services 122 may interact with knowledge management platform 102 as described herein. Knowledge management platform 102 may also interact with other systems and services not shown in FIG. 1.

Data communication network 104 includes any type of network topology using any communication protocol. Additionally, data communication network 104 may include a combination of two or more communication networks. In some embodiments, data communication network 104 includes a cellular communication network, the Internet, a local area network, a wide area network, or any other communication network. In environment 100, data communication network 104 allows communication between knowledge management platform 102, user device 106, third party device 108, and any number of other systems and services, such as email service 112, communication service 114, LinkedIn and other networking services 116, third party data sources and services 118, human resources systems 120, and assessment services 122.

Although one user device 106 is shown in FIG. 1, particular embodiments may include any number of user devices 106 that can each communicate with any of the components or systems illustrated in FIG. 1. Further, any number of third party devices 108, email services 112, communication services 114, LinkedIn and other networking services 116, third party data sources and services 118, human resources systems 120, and assessment services 122 may be included in particular embodiments and configured to communicate with any of the components or systems illustrated in FIG. 1.

In some embodiments, environment 100 further includes a cloud infrastructure provider 124 and one or more external vendors 126. As described herein, cloud infrastructure provider 124 may support various systems and functions, such as web servers, databases, caches, and worker processes. As discussed in greater detail herein, external vendors 126 may include, for example, artificial intelligence services, authorization services, scheduling services, and the like. In some embodiments, one or more of external vendors 126 may be accessed via an API (application programming interface).

It will be appreciated that the embodiment of FIG. 1 is given by way of example only. Other embodiments may include fewer or additional components without departing from the scope of the disclosure. Additionally, illustrated components may be combined or included within other components without limitation.

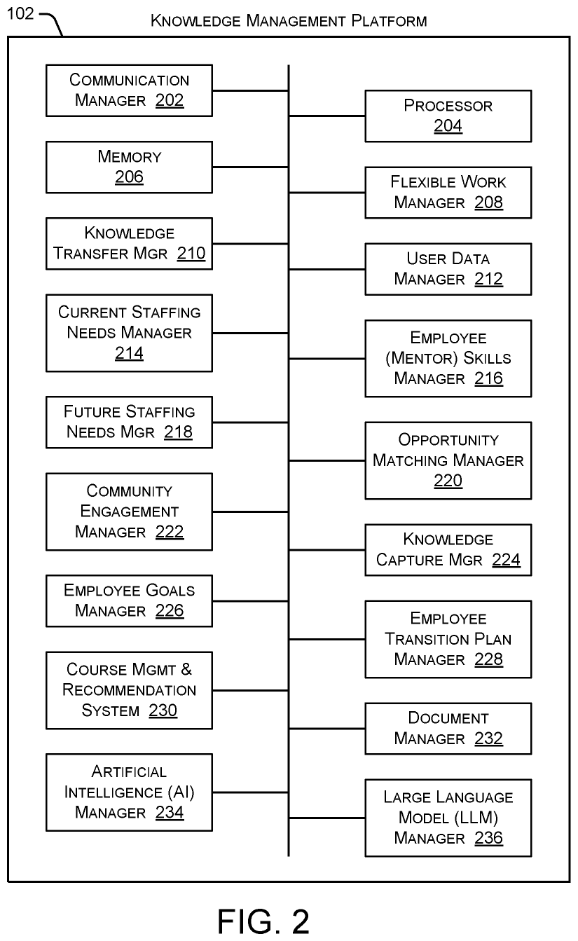

FIG. 2 is a block diagram illustrating an embodiment of knowledge management platform 102. As shown in FIG. 2, knowledge management platform 102 may include a communication manager 202, a processor 204, and a memory 206. Communication manager 202 allows knowledge management platform 102 to communicate with other systems, such as user device 106 and third party device 108 shown in FIG. 1, and the like. Processor 204 executes various instructions to perform the functionality provided by knowledge management platform 102, as discussed herein. Memory 206 stores these instructions as well as other data used by processor 204 and other modules and components contained in knowledge management platform 102.

Additionally, knowledge management platform 102 includes a flexible work manager 208 and a knowledge transfer manager 210. Flexible work manager 208 may handle various functions related to finding positions and work assignments that satisfy the needs and preferences of employees seeking semi-retirement, different roles, and the like. Knowledge transfer manager 210 assists with the scheduling and transfer of knowledge from, for example, senior employees to younger or less experienced employees. In some embodiments, knowledge transfer manager 210 may create a relationship graph of other team members who are associated with (e.g., communicate regularly with) a mentor who is transferring their knowledge to the other team members. This relationship graph may be created based on information in an email service or other communication services, such as Slack.

Knowledge management platform 102 further includes a user data manager 212 that manages data such as user preferences, user profile information, user skills, user roles, and the like. A current staffing needs manager 214 determines current staffing needs and may identify employees who are approaching retirement, or already semi-retired, with skills needed to fill open staffing needs. An employee (mentor) skills manager 216 monitors various employee skills and identifies potential opportunities to transfer the skills knowledge to other employees.

A future staffing needs manager 218 may predict future staffing and/or skills needed by the organization and take steps to train or recruit employees to meet the future staffing or skills needs. An opportunity matching manager 220 can help employees identify opportunities (such as part-time positions) that match their skills, preferences, and the like.

A community engagement manager 222 may provide various functions, such as helping individuals, groups, or cohorts with activities, events, online meetings, facilitating discussions, and the like. Community engagement manager may also share stories and other content that may be of interest to at least some of the community members. In some embodiments, an artificial intelligence based system may assist with any of the functions. The community may include current employees, former employees, and the like.

Knowledge management platform 102 also includes a knowledge capture manager 224 that may handle the identification and transfer of knowledge from senior employees to younger employees or less-experienced employees. An employee goals manager 226 may keep track of employee goals, such as goals associated with different roles in the organization, retirement, semi-retirement, and the like. An employee transition plan manager 228 may assist with an employee's transition from full-time employee to semi-retirement or full retirement. For example, the transition may include knowledge and skills transfer to one or more other employees in the organization.

A course management and recommendation system 230 may provide training recommendations to employees who are, for example, approaching retirement or who are semi-retired. The training recommendations may include courses and other training programs related to transitioning to retirement, sharing knowledge with co-workers, and the like. The specific recommendations may be based on the employee's preferences, work status, and other factors. A document manager 232 handles various documents related to employees, semi-retirement activities, employee retirement, internal company processes, knowledge transfer (e.g., knowledge transfer schedules and templates), and the like.

Knowledge management platform 102 further includes an artificial intelligence (AI) manager 234 and a large language model (LLM) manager 236. In some embodiments, AI manager 234 manages various tasks and activities related to AI systems and methods discussed herein. Some embodiments of LLM manager 236 manage the operation of one or more LLM systems or services. For example, LLM manager 236 may manage the creation and sending of prompts to an LLM service, receiving responses from the LLM service, communicating with other systems that create prompts or receive responses, and the like.

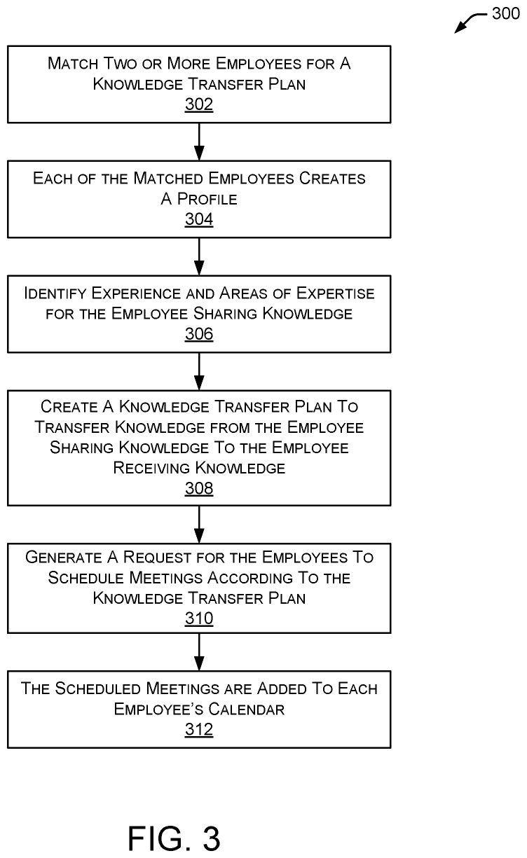

FIG. 3 is a flow diagram illustrating an embodiment of a method 300 for setting up a knowledge transfer plan. In some embodiments, the knowledge transfer plan facilitates high-value sessions between knowledge partners that support the transfer of knowledge from, for example, an expert to a learner. The knowledge transfer plan identifies multiple sessions covering different topics that are important to the learner who will be working in a new role or situation. As the knowledge is captured, it may be stored for future access by the learner or by other individuals in the organization.

Initially, method 300 matches 302 two or more employees for a knowledge transfer plan. For example, one of the employees may be a senior employee with significant experience in their role with the company. The other employee may be a new employee or someone with less experience who wants to learn (e.g., transfer knowledge) from the senior employee. In some situations, the matching 302 of two or more employees for a knowledge transfer plan may be performed by a company leader, an HR (human resources) employee, or any other employee in the organization. In other embodiments, the matching 302 may include the use of a tool (e.g., matching software) that suggests possible matches based on various factors, such as the topic of the knowledge transfer, available experts to train less experienced employees, and the like.

Method 300 continues as each of the matched employees creates 304 a profile. The profile of each matched employee may include an employee bio, work experience, current position with the company, interests, goals for the knowledge transfer plan, and the like. The method continues by identifying 306 experience and areas of expertise for the employee sharing knowledge. The employee's experience and expertise can be identified 306 based on the employee's work history, current role in the company, user profile, and the like.

Method 300 continues by creating 308 a knowledge transfer plan to transfer knowledge from the employee sharing knowledge to the employee receiving knowledge. In some embodiments, the knowledge transfer plan identifies various aspects of the knowledge transfer activities. For example, a particular knowledge transfer plan may identify the employees involved, the topic (e.g., work-related topic) associated with the knowledge transfer, a timeline for completing the knowledge transfer activities, a recommended schedule for meetings between the employees, and the like.

The method continues by generating 310 a request for the employees participating in the knowledge transfer plan to schedule meetings according to the knowledge transfer plan. In some embodiments, the method may suggest meeting times based on the timeline in the knowledge transfer plan and the availability on each employees' calendar. The scheduled meetings are then added 312 to each employee's calendar. In some embodiments, the scheduled meetings are also added to the information in the knowledge transfer plan as well as one or more templates associated with the knowledge transfer plan, as discussed herein.

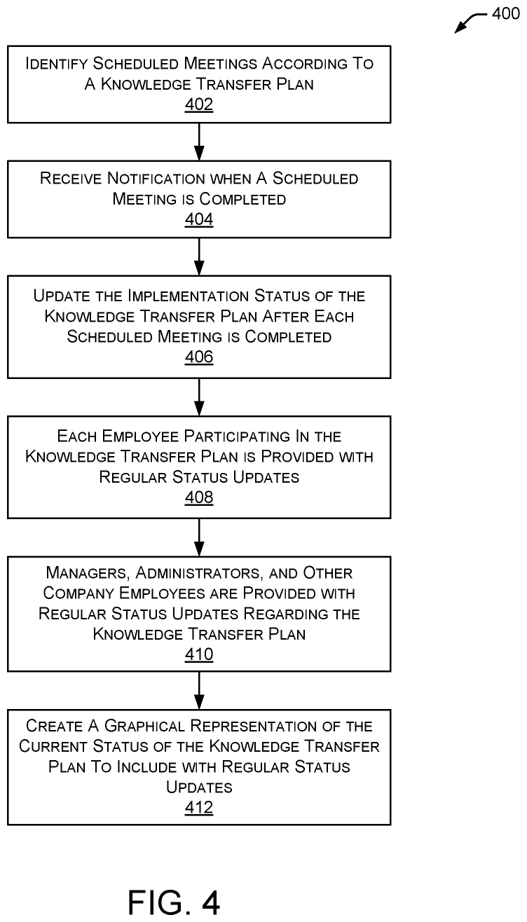

FIG. 4 is a flow diagram illustrating an embodiment of a method 400 for monitoring implementation of a knowledge transfer plan. Initially, method 400 identifies 402 scheduled meetings according to a knowledge transfer plan. As discussed herein, a typical knowledge transfer plan may have multiple meetings scheduled between the employees to discuss various topics and share information related to the knowledge being transferred.

Method 400 receives 404 a notification when a scheduled meeting is completed. The method then updates 406 the implementation status of the knowledge transfer plan after each scheduled meeting is completed. The update 406 of the implementation status may include the new meeting completion information as well as a recording of the meeting, a transcript of the meeting, and a summary of the meeting, as discussed herein.

The method continues by providing 408 each employee participating in the knowledge transfer plan with regular status updates. In some embodiments, the regular status updates may include at least a portion of the updated 406 implementation status discussed above. Additionally, managers, administrators, HR personnel, and other company employees may be provided 410 with regular status updates regarding the knowledge transfer plan.

In some implementations, method 400 creates 412 a graphical representation of the current status of the knowledge transfer plan to include with regular status updates. For example, the graphical representation of the current status of the knowledge transfer plan may show trends or other information that allows a viewer to quickly visualize the progress being made toward completing the knowledge transfer plan.

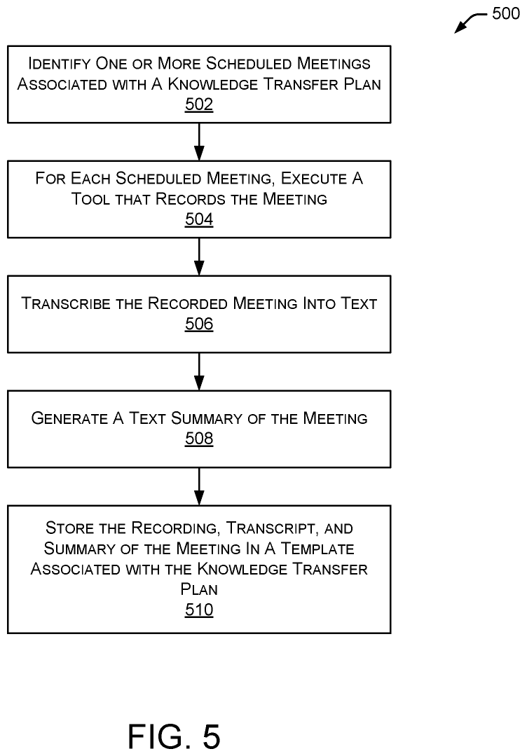

FIG. 5 is a flow diagram illustrating an embodiment of a method 500 for recording, transcribing, and summarizing meetings associated with a knowledge transfer plan. Initially, method 500 identifies 502 one or more scheduled meetings associated with a knowledge transfer plan. For each scheduled meeting, the method executes 504 a tool or application that records the meeting. For example, an application or web-based service may record the meeting in audio and/or video format.

After the meeting is finished, the method transcribes 506 the recorded meeting into text, such as a text file. In some embodiments, transcribing 506 the recorded meeting is performed by an artificial intelligence-based tool, such as a large language model, capable of automatically transcribing the recording into text. The method continues by generating 508 a text summary of the meeting. The text summary provides a short summary that can be read quickly as compared to the full-length transcript. In some embodiments, generating 508 the text summary is performed by an artificial intelligence-based tool, such as a large language model, capable of automatically summarizing the recording into a text summary or summarizing the transcript into a text summary.

Method 500 continues by storing 510 the recording, the transcript, and the summary of the meeting in a template associated with the knowledge transfer plan or other storage mechanism. In some embodiments, the template may be customized by each company based on the company's preferences and most important information in the knowledge transfer plan. In some embodiments, each template identifies suggested topics for knowledge partner discussions, scheduling suggestions for the knowledge partner discussions, and the like.

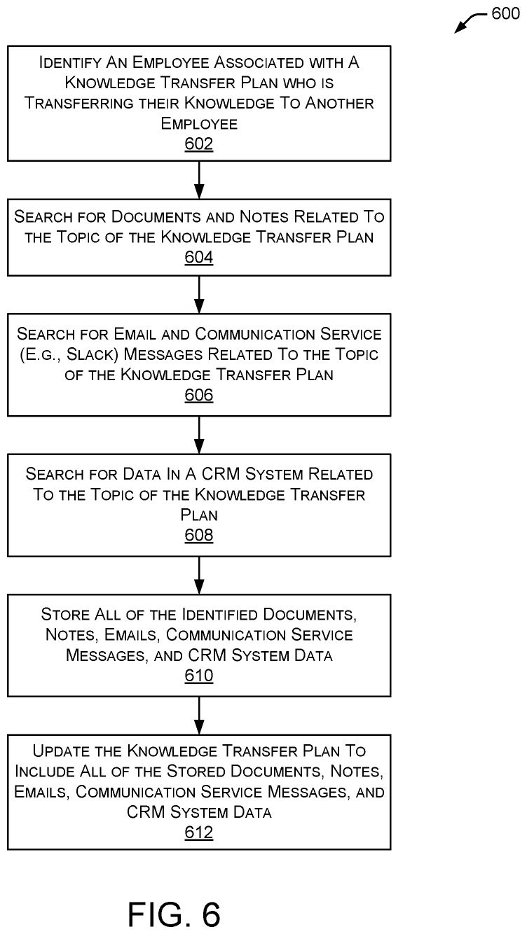

FIG. 6 is a flow diagram illustrating an embodiment of a method 600 for identifying and retrieving data from multiple sources associated with a knowledge transfer plan. Initially, method 600 identifies 602 an employee associated with a knowledge transfer plan who is transferring their knowledge to another employee. The method searches 604 for documents and notes related to the topic of the knowledge transfer plan. For example, the documents and notes may have been created during the regular work activities by the employee who is transferring their knowledge. These documents and notes may provide information regarding insights, standard operating procedures, and other details that are helpful to the employee receiving the transferred knowledge. In some embodiments, the documents and notes may be summarized or otherwise processed using a large language model or other artificial intelligence system.

Method 600 continues by searching 606 for email and communication service messages related to the topic of the knowledge transfer plan. The communication service messages may be associated with a Slack channel or any other type of communication service. For example, the email and communication service messages may have been created during the regular work activities by the employee who is transferring their knowledge. These email and communication service messages can provide information regarding insights, standard operating procedures, and other details that are helpful to the employee receiving the transferred knowledge. In some embodiments, the email and communication service messages may be summarized or otherwise processed using a large language model or other artificial intelligence system.

The method continues by searching 608 for data in a CRM (customer relationship management) system. The CRM system data may be associated with a variety of customer-related activities. For example, the CRM system data may have been created during the regular work activities by the employee who is transferring their knowledge. This CRM system data can provide information regarding insights, standard operating procedures, and other details that are helpful to the employee receiving the transferred knowledge. In some embodiments, the CRM system data may be summarized or otherwise processed using a large language model or other artificial intelligence system.

Method 600 stores 610 all of the identified documents, notes, email messages, communication service messages, and CRM system data. In some embodiments, the stored information may be combined with other data in a template or the knowledge transfer plan to provide additional training and a more valuable collection of information regarding the topic of the knowledge transfer plan.

The method then updates 612 the knowledge transfer plan (or associated storage systems) to include all of the stored documents, notes, email messages, communication service messages, and CRM system data. Thus, the template associated with the knowledge transfer plan may include meeting recordings, meeting transcripts, meeting summaries, stored documents, notes, email messages, communication service messages, and CRM system data. In some embodiments, all of this information is used collectively to capture multiple aspects of the topic of the knowledge transfer plan. As discussed herein, this collection of information may be analyzed to identify multiple types of knowledge that is valuable to the receiving employee.

In some embodiments, the information and data collected and summarized in FIGS. 5 and 6 may be aggregated to extract summaries and important information from all of the information and data. For example, the method 500 transcribes and summarizes meetings between knowledge partners. The method 600 extracts and summarizes data from documents, notes, email messages, communication service messages, data in CRM systems, and the like. In some embodiments, all of the information and data collected by methods 500 and 600 may be provided to a large language model (or other artificial intelligence system) to aggregate the data, extract summaries of the aggregated data, answer user questions regarding the aggregated data, identify the most important information in the aggregated data, and the like. In some implementations, the aggregated data (or summaries of the aggregated data) may be added to the knowledge transfer plan. In particular embodiments, a user may query the aggregated data with a prompt or question, such as “Where did participants struggle with their understanding of what they were working on?” or “What is the code deployment process like at Acme?”

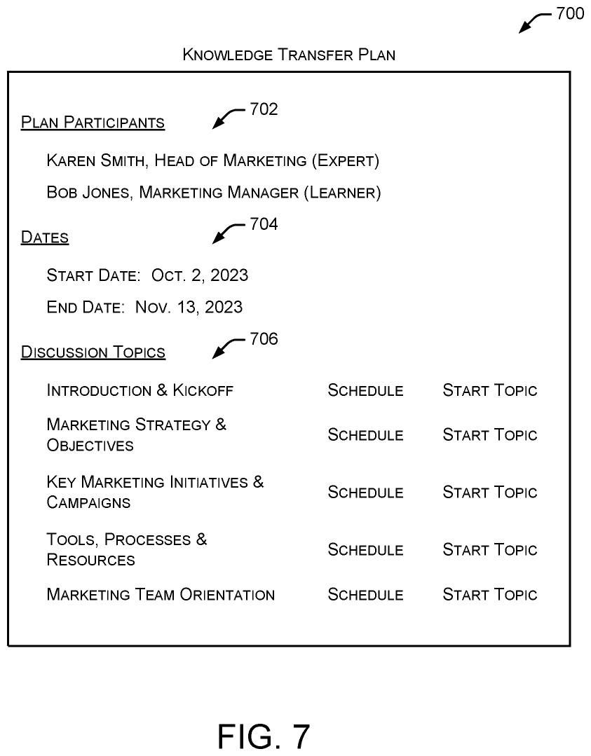

FIG. 7 illustrates an example knowledge transfer plan 700. As shown in FIG. 7, knowledge transfer plan 700 includes plan participants 702, dates 704, and discussion topics 706. Plan participants 702 may also be referred to as “knowledge partners.” In the example of FIG. 7, Karen Smith is an experienced marketing employee who will be sharing her knowledge with Bob Jones, who has less experience in a marketing role. In some situations, Bob Jones may be a new hire who is being trained for his marketing manager role. In other situations, Bob Jones may have been promoted and is training for his new role.

As mentioned above, knowledge transfer plan 700 includes dates 704 that provide approximate start and end dates for the knowledge transfer activities. In the example of FIG. 7, dates 704 provide approximately six weeks to complete knowledge transfer plan 700. Discussion topics 706 provide five different topics to be discussed by Karen and Bob during five scheduled meetings. In other embodiments, knowledge transfer plan 700 may include any number of discussion topics 706 depending on the topic, the experience of the person receiving the knowledge, and the like. In some implementations, knowledge transfer plan 700 may include schedule buttons and/or start topic buttons to schedule meetings and/or start a particular topic related to one of the discussion topics 706.

Although the example knowledge transfer plan 700 includes plan participants 702, dates 704, and discussion topics 706, alternate embodiments may include other types of information. For example, particular implementations of transfer plan 700 may include more details regarding discussion topics (e.g., specific questions or sub-topics to discuss), a company representative responsible for monitoring the knowledge transfer plan, and the like.

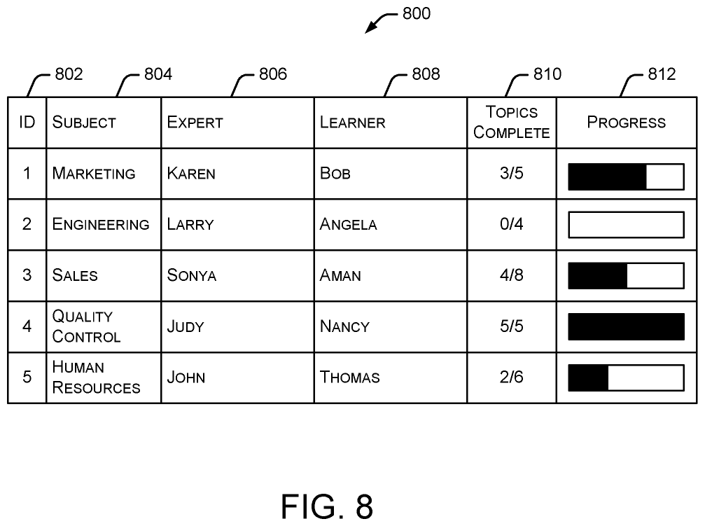

FIG. 8 illustrates an example representation 800 of the current status of a knowledge transfer plan. The representation 800 includes multiple status details for five different knowledge transfer plans identified 802 as 1-5. The status of each knowledge transfer plan includes a subject 804, an expert 806, a learner 808, topics complete 810, and progress 812. Subject 804 shown in FIG. 8 identifies a general subject 804 of the knowledge transfer plan. In other embodiments, subject 804 may include a more detailed description of the knowledge transfer plan. Expert 806 is a person sharing their knowledge on the subject and learner 808 is the person receiving the knowledge from expert 806. Topics complete 810 indicate how many of the scheduled topics associated with the knowledge transfer plan. For example, for ID 1 (Karen and Bob), three of the five scheduled topics have been completed. Progress 812 indicates graphically how much of the knowledge transfer plan has been completed. In the example of ID 1, Karen and Bob have completed 60% of the scheduled topics as illustrated in progress bar 812 being 60% filled.

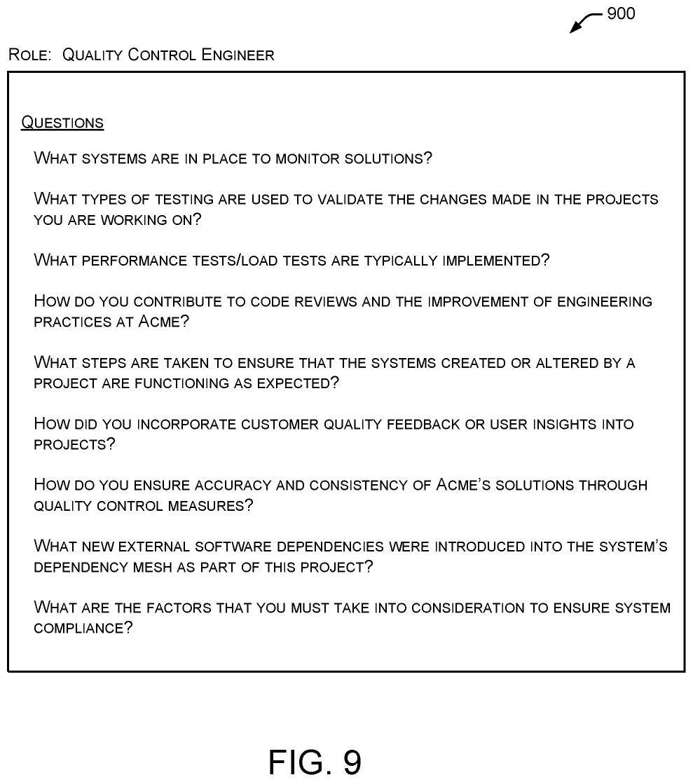

FIG. 9 illustrates an example template 900 associated with a knowledge transfer plan. In the example of FIG. 9, template 900 is associated with a particular role, Quality Control Engineer. Template 900 includes questions to be discussed during one or more sessions associated with a knowledge transfer plan. In some embodiments, template 900 may include additional questions, discussion topics, conversation starters, and the like that are now shown in FIG. 9. In particular implementations, template 900 may be used to help create a knowledge transfer plan (e.g., how many meetings to discuss questions, which topics to discuss, or other information). In some situations, multiple templates 900 may be associated with a particular role. For example, multiple templates 900 may be provided for the Quality Control Engineer role. The multiple templates 900 may include different content based on the learner's experience in the role, the time available to implement the knowledge transfer plan, and the like.

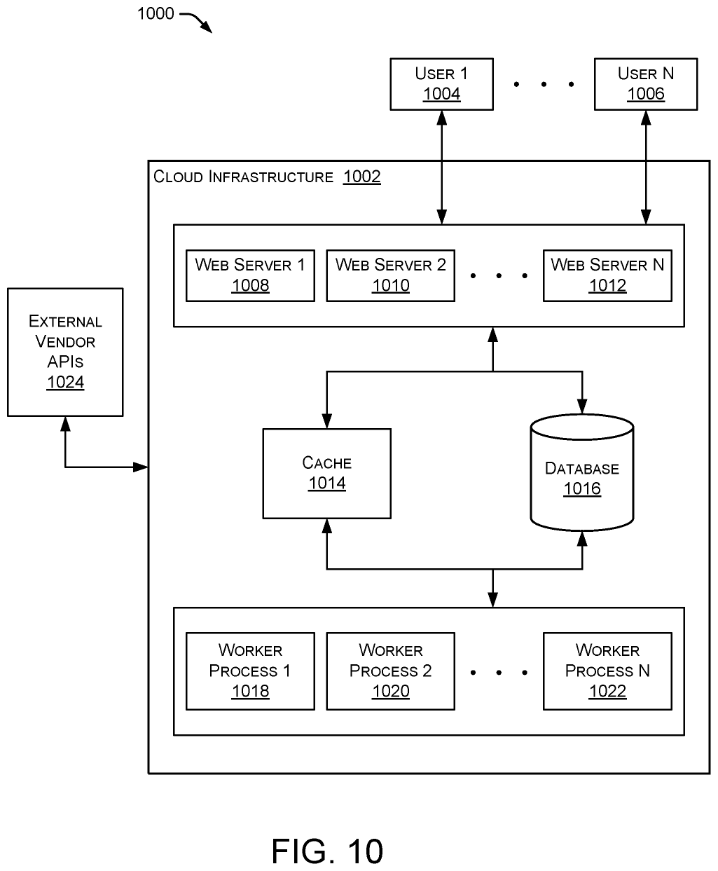

FIG. 10 is a block diagram illustrating an embodiment of a network architecture 1000. As shown in FIG. 10, network architecture 1000 may include a cloud infrastructure 1002 that can be supported by a cloud infrastructure provider, such as cloud infrastructure provider 124 shown in FIG. 1. In some embodiments, cloud infrastructure 1002 includes a virtual private cloud. In other embodiments, network architecture 1000 may use one or more infrastructures that do not include a cloud infrastructure.

In some embodiments, any number of users 1004, 1006 may access cloud infrastructure 1002. Users 1004, 1006 may include participants in a knowledge transfer process, administrators of knowledge management platform 102, and anyone else involved in or supporting the systems and methods discussed herein. In particular implementations, users 1004, 1006 may interact with any number of web servers 1008, 1010, 1012 contained in cloud infrastructure 1002. Web servers 1008, 1010, 1012 may perform a variety of operations related to the knowledge transfer process, as discussed herein.

As shown in FIG. 10, any of web servers 1008, 1010, 1012 may support connections with users 1004, 1006 to access data and other information via a cache 1014 and a database 1016. In some embodiments, any number of worker processes 1018, 1020, 1022 may also access cache 1014 and database 1016. Database 1016 stores a variety data used by any of web servers 1008, 1010, 1012 and/or worker processes 1018, 1020, 1022. Cache 1014 may be a high-performance cache that stores data used by any of web servers 1008, 1010, 1012 and/or worker processes 1018, 1020, 1022. In some embodiments, cache 1014 is used to store data that may require fast retrieval in the near future and database 1016 is used to store data that may require slower retrieval at a later time.

In some implementations, worker processes 1018, 1020, 1022 can perform a variety of tasks associated with the knowledge transfer processes discussed herein, such as transcribing meetings, summarizing meetings, and the like. Some of the tasks performed by worker processes 1018, 1020, 1022 may not be time-critical and can be queued to run when a worker process is available. Additionally, the number of executing worker processes may change based on the current demand for worker processing.

As shown in FIG. 10, network architecture 1000 further includes one or more external vendor APIs 1024, which may be accessed by web servers 1008, 1010, 1012 or worker processes 1018, 1020, 1022. External vendor APIs 1024 may perform a variety of operations and services, such as artificial intelligence services, authorization services, authentication services, security services, scheduling services, virtual bot services, and the like. For example, one or more external vendor APIs 1024 may allow one of the web servers 1008, 1010, 1012 or worker processes 1018, 1020, 1022 to access artificial intelligence services that may include an LLM (large language model). An LLM is a machine-learning neural network that is trained on a large set of data. In other embodiments, scheduling services may support the scheduling of knowledge transfer meetings attended by two or more people. The scheduling services may coordinate scheduling of the meeting and update calendars associated with the meeting attendees. Additionally, virtual bot services may automatically record the meeting at the scheduled time.

As shown in FIG. 10, webservers 1008, 1010, 1012 can access cache 1014 and database 1016, but they cannot access worker processes 1018, 1020, 1022. Similarly, worker processes 1018, 1020, 1022 can access cache 1014 and database 1016, but they cannot access webservers 1008, 1010, 1012. This architecture provides security for the system. For example, if an attacker gets access to a webserver 1008, 1010, 1012, they cannot access any worker process 1018, 1020, 1022. Similarly, if an attacker gets access to a worker process 1018, 1020, 1022, they cannot access any webserver 1008, 1010, 1012.

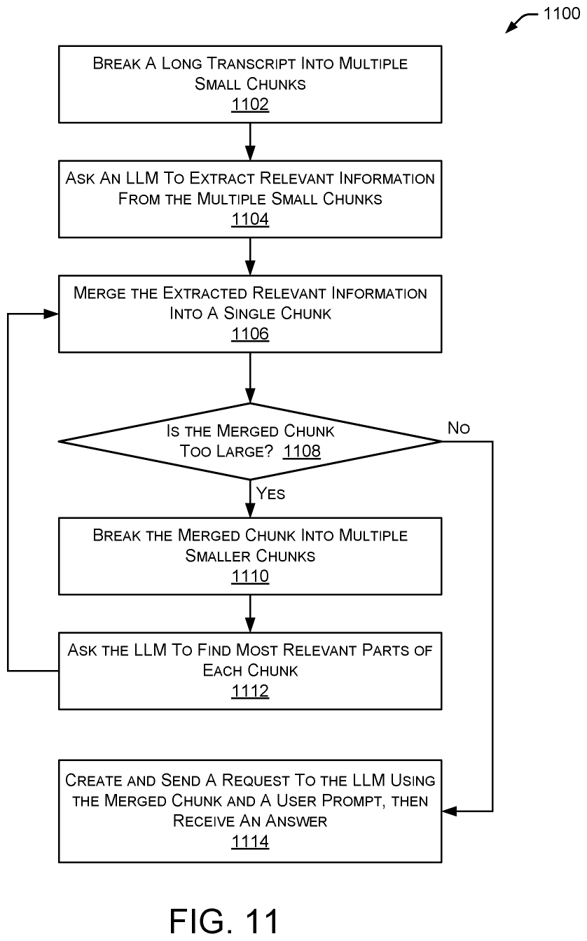

FIG. 11 is a flow diagram illustrating an embodiment of a method 1100 for generating an LLM request. In some embodiments, method 1100 is performed in response to a question received by a user. Initially, method 1100 breaks 1102 a long transcript or other long document into multiple small chunks. For example, the transcript may be associated with one or more meetings between two or more participants in a knowledge transfer plan. Each of the small chunks are small enough for an LLM to process in a single query. The size of each small chunk may vary depending on the requirements or guidelines of the particular LLM being used. In some embodiments, LLMs are limited on the number of tokens (e.g., a unit of information) they can accept in a single query. For example, tokens may contain basic units of text, code, or other information that may be used to process and create results. Each token may contain words, portions of words, portions of sentences, and the like. In some implementations, an LLM can accept 10,000 or more tokens in a single request.

Each of the small chunks are provided to an LLM to extract 1104 relevant information from each small chunk. In some embodiments, each small chunk is processed by the LLM in isolation. The query provided to the LLM to extract 1104 relevant information is an “extraction” query. The purpose of the extraction query is to identify and extract all information relevant to the question submitted by the user. In some embodiments, the extraction query is designed to reduce the dataset in size. For example, an extraction query may return a bulleted list of all data points that support the response to the question below.
Question: #(query_prompt)
Data: #(query_text)

Method 1100 continues by merging 1106 the extracted relevant information into a single chunk. In some embodiments, merging 1106 the extracted relevant information includes concatenation of the data into a single chunk. For example, the data may be represented as text stored in memory. The method continues by determining 1108 whether the merged chunk is too large for the LLM to process (e.g., too large to send to the LLM). As discussed above, an LLM may be limited in the number of tokens it can accept in a single request.

If the merged chunk is too large, the method breaks 1110 the merged chunk into multiple smaller chunks. The multiple smaller chunks are then provided 1112 to the LLM to extract relevant information from the smaller chunks. This process of repeating the extraction query gradually reduces the size of the concentrated list of relevant data. If the merged chunk is not too large, the method creates and sends 1114 a request to the LLM using the merged chunk and a user prompt. In some embodiments, the request is a “presentation query” that is intended to generate a relevant answer based on all of the context extracted in the method steps discussed above. Based on the request, the LLM provides an answer to the request. In some embodiments, an example prompt for this type of query is provided below.

%(
Return your response in this format: Answer: <answer>
\n\nSupporting Data: <data points that support your answer>
\n\nConfidence Score: <confidence score as percentage value>
Question: #(query_prompt)
Data: #(query_text)
)

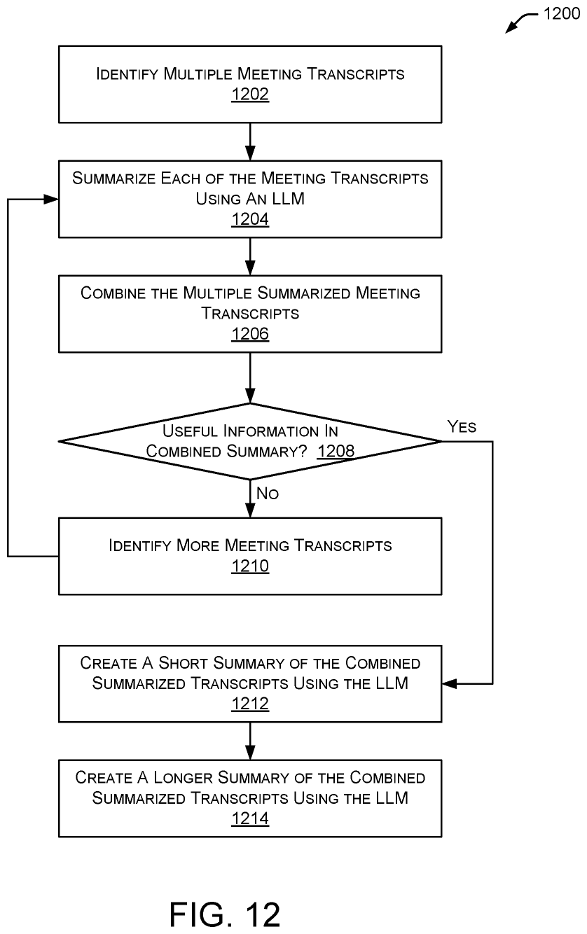

FIG. 12 is a flow diagram illustrating an embodiment of a method 1200 for summarizing multiple meeting transcripts. Initially, method 1200 identifies 1202 multiple meeting transcripts. The method continues by summarizing 1204 each of the meeting transcripts using an LLM. In some embodiments, the transcript is summarized into a single short paragraph. An example prompt for this type of transcript summarization is provided below.

Only return a one-paragraph summary—do not include any titles or headings.
#(transcript_text)

Method 1200 continues by combining 1206 the multiple summarized meeting transcripts. In some embodiments, combining 1206 the multiple summarized meeting transcripts includes concatenation of the data into a single document or transcript. The method 1200 determines 1208 whether the combined summary includes useful information. In some embodiments, the information is considered to be “useful” if the LLM determines that it is relevant to the prompt.

If the method determines that the combined summary information is not useful, the method identifies 1210 more meeting transcripts and returns to 1204 to continue summarizing the additional meeting transcripts. If the method determines that the combined summary information is useful, the combined summarized transcripts are provided to the LLM to create 1212 a short summary of the combined summarized transcripts. The following paragraph is an example output of a summarized transcript.

The transcript covers various themes including stories about first jobs, technical difficulties with Acme, an icebreaker activity, meeting logistics and screen sharing, discussion about access and permissions, personal experiences with first jobs, challenges and experiences of first jobs, miscellaneous conversations, general meeting logistics and communication, launch and delivery themes, customer support, progress reporting, SSO setup and permission, case study creation, security, templates, video integration and feature development, bug fixes, ad hoc changes, client management, pairing process, knowledge transfer, continuum-improve-stop, contemplating the need to stop or continue a certain activity, template creation process, creating ad hoc templates, ad hoc changes and iterations, Azure integration, app and asset creation, summary display, meeting timeout changes, template improvements, control tower and progress dashboard, meeting launch issues, time and energy constraints, bug fixing process, communication channels, progress reporting, customer support, ad hoc processes, society metrics, user engagement, client support, dashboard updates, webinars and instructional content, customer support feedback, stop-start-continue-improve, design and development, and a theme about requesting feedback and improvement.

In some embodiments, method 1200 may also request the LLM to create 1214 a longer summary of the combined summarized transcripts. The summaries of different lengths give users different options for the amount of detail they want in a summary.

In some embodiments, the systems and methods described herein may implement a recursive summarization process and a recursive querying process. The recursive summarization process repeatedly requests summaries for chunks of data from an LLM until the entire set of data is small enough to generate a complete summary. This result may be considered as a summary of the summaries.

In some embodiments, the recursive summarization process performs a first iteration by breaking a transcript into multiple chunks that are each sent to an LLM to summarize. In subsequent iterations, each successive request to the LLM includes summaries that were generated from the previous cycles. The last iteration returns a summary of the entire transcript, either a brief summary or a verbose summary depending on the request. A prompt may be generated that is related to requesting a summary of the knowledge transfer data. In some embodiments, a system message is used to specify the persona used by the LLM in its replies. The system message may be sent with every request to the LLM. For the recursive summarization process, an example system prompt is “You are a summarization API that works on transcripts of audio conversations.”

The recursive querying process repeatedly asks a question on chunks of data from an LLM. This continues until the generated responses are small enough to send a final request to receive an answer to the question based on all of the relevant data. In some embodiments, the recursive querying process performs a first iteration by breaking a series of transcripts and other knowledge transfer data into smaller chunks that are sent to the LLM along with a user-generated query. In subsequent iterations, each successive request to the LLM includes answers and supporting data to the user question generated from the previous cycles as well as the user-generated question. The last iteration returns an answer to the user-generated question with details and supporting extracted data from the knowledge transfer data. A prompt may be generated that requests the generation of an answer and supporting data to the query. In some embodiments, a system message is used to specify the persona used by the LLM in its replies. The system message may be sent with every request to the LLM. For the recursive querying process, an example system prompt is “You are an API that answers queries based on transcripts from conversations between employees sharing knowledge with each other. You will be provided with a user's question and a collection of transcript data to inform your answer. Please use the data to answer the question. Please use the participants' names or the pronouns “they” and “them” when referring to all participants. Do not use first person.”

In some situations, the systems and methods described herein may be used to avoid or minimize layoffs. For example, rather than laying off employees, the systems and methods can help employers reduce the hours of multiple employees to reduce the number of employees that need to be laid off. In some situations, the systems and methods may help identify different jobs for certain employees that match the employees' skills/experience, but are fewer hours. Thus, the employee can retain those employees, but assign them to a job with lower pay to minimize the number of layoffs needed. In these situations, the knowledge transfer systems discussed herein may be used to train employees to perform different roles within the organization.

In some embodiments, the described systems and methods are used to onboard new employees. For example, the systems and methods may provide an onboarding process associated with a new employee's job, which may include training, knowledge transfer from other employees, mentoring, and the like. A similar approach may be used for existing employees who are transitioning to a new role in the company and require training associated with that role.

In other situations, the systems and methods described herein may be used when divesting a company. For example, if portions of a company are being separated, it is important to keep appropriate knowledge with each remaining portion of the company. The described systems and methods can support knowledge transfer between knowledge partners to be sure each portion of the company retains the knowledge necessary to continue efficient operation.

In other embodiments, the systems and methods described herein can be used to transfer or retain knowledge during mergers, acquisitions, and other business activities. In situations involving a company reorganization, the described systems and methods are useful to transfer knowledge to different team members based on the reorganization of people, roles, and the like.

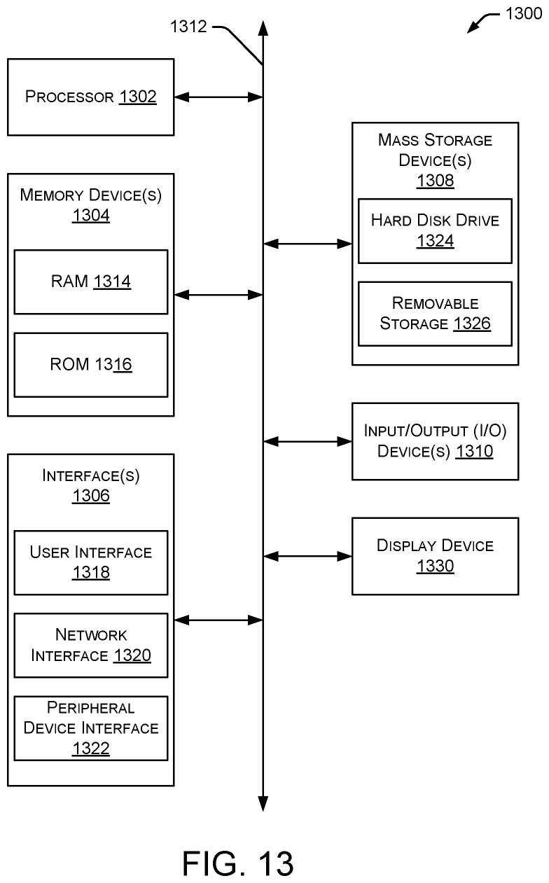

FIG. 13 illustrates an example block diagram of a computing device 1300. Computing device 1300 may be used to perform various procedures, such as those discussed herein. For example, computing device 1300 may perform any of the functions or methods of the computing devices and systems discussed herein, such as the knowledge management platform. Computing device 1300 can further execute one or more application programs, such as the application programs or functionality described herein. Computing device 1300 can be any of a wide variety of computing devices, such as a desktop computer, a notebook computer, a server computer, a handheld computer, tablet computer, a wearable device, and the like.

Computing device 1300 includes one or more processor(s) 1302, one or more memory device(s) 1304, one or more interface(s) 1306, one or more mass storage device(s) 1308, one or more Input/Output (I/O) device(s) 1310, and a display device 1330 all of which are coupled to a bus 1312. Processor(s) 1302 include one or more processors or controllers that execute instructions stored in memory device(s) 1304 and/or mass storage device(s) 1308. Processor(s) 1302 may also include various types of computer-readable media, such as cache memory.

Memory device(s) 1304 include various computer-readable media, such as volatile memory (e.g., random access memory (RAM) 1314) and/or nonvolatile memory (e.g., read-only memory (ROM) 1316). Memory device(s) 1304 may also include rewritable ROM, such as Flash memory.

Mass storage device(s) 1308 include various computer readable media, such as magnetic tapes, magnetic disks, optical disks, solid-state memory (e.g., Flash memory), and so forth. As shown in FIG. 13, a particular mass storage device is a hard disk drive 1324. Various drives may also be included in mass storage device(s) 1308 to enable reading from and/or writing to the various computer readable media. Mass storage device(s) 1308 include removable media 1326 and/or non-removable media.

I/O device(s) 1310 include various devices that allow data and/or other information to be input to or retrieved from computing device 1300. Example I/O device(s) 1310 include cursor control devices, keyboards, keypads, microphones, monitors or other display devices, speakers, printers, network interface cards, modems, and the like.

Display device 1330 includes any type of device capable of displaying information to one or more users of computing device 1300. Examples of display device 1330 include a monitor, display terminal, video projection device, and the like.

Interface(s) 1306 include various interfaces that allow computing device 1300 to interact with other systems, devices, or computing environments. Example interface(s) 1306 may include any number of different network interfaces 1320, such as interfaces to local area networks (LANs), wide area networks (WANs), wireless networks, and the Internet. Other interface(s) include user interface 1318 and peripheral device interface 1322. The interface(s) 1306 may also include one or more user interface elements 1318. The interface(s) 1306 may also include one or more peripheral interfaces such as interfaces for printers, pointing devices (mice, track pad, or any suitable user interface now known to those of ordinary skill in the field, or later discovered), keyboards, and the like.

Bus 1312 allows processor(s) 1302, memory device(s) 1304, interface(s) 1306, mass storage device(s) 1308, and I/O device(s) 1310 to communicate with one another, as well as other devices or components coupled to bus 1312. Bus 1312 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1300, and are executed by processor(s) 1302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
identifying, by a knowledge management platform, a knowledge transfer plan for transferring knowledge from a first person to a second person, wherein the knowledge transfer plan is associated with a topic;
identifying, by the knowledge management platform, a meeting between the first person and the second person to transfer knowledge therebetween;
generating, by the knowledge management platform, a summary of the meeting:
accessing, by the knowledge management platform, data from an external source that is related to the topic of the knowledge transfer plan; and
aggregating, by the knowledge management platform, the summary of the meeting and the data from an external source into the knowledge transfer plan.

2. The method of claim 1, wherein the first person possesses knowledge related to the topic and the second person wants to receive knowledge related to the topic.

3. The method of claim 1, wherein the knowledge transfer plan includes:
details regarding topics to be discussed by the first person and the second person; and
a timeframe for scheduling meetings between the first person and the second person.

4. The method of claim 1, further comprising:
identifying a completed meeting between the first person and the second person; and
updating an implementation status of the knowledge transfer plan to indicate completion of the meeting between the first person and the second person.

5. The method of claim 1, further comprising generating a template associated with the knowledge transfer plan, wherein the template identifies suggested topics and schedule information associated with the knowledge transfer plan.

6. The method of claim 1, wherein the data from an external source includes at least one of a document, recorded notes, an email message, a communication service message, or CRM (customer relationship management) system data.

7. The method of claim 1, further comprising:
detecting activity associated with the knowledge transfer plan; and
updating the knowledge transfer plan based on the detected activity.

8. The method of claim 1, further comprising:
analyzing the aggregated meeting summary and external data to identify at least one of employee roles, experiences, or activities associated with the knowledge transfer plan.

9. The method of claim 1, wherein the summary of the meeting is generated by a large language model that processes a recording of the meeting between the first person and the second person.

10. The method of claim 1, wherein the aggregating of the summary of the meeting and the data from an external source includes providing the summary of the meeting and the data from an external source to a large language model.

11. The method of claim 10, wherein the large language model returns an aggregated summary that includes the summary of the meeting and the data from the external source.

12. The method of claim 10, further comprising submitting a prompt to the large language model to obtain an answer associated with the prompt.

13. The method of claim 12, wherein the prompt is associated with a question about at least one of knowledge transfer meetings, knowledge transfer plans, or knowledge transfer plan status.

14. The method of claim 1, further comprising:
identifying a meeting transcript;
breaking the meeting transcript into a plurality of smaller chunks;
prompting a large language model to extract relevant information from each of the plurality of smaller chunks; and
merging the extracted relevant information from each chunk into a single chunk.

15. The method of claim 14, further comprising:
creating a request that includes a question;
providing the request to the large language model using the merged chunk; and
receiving an answer from the large language model.

16. A system comprising:
one or more processors; and
one or more non-transitory computer-readable media storing instructions executable by the one or more processors, wherein the instructions, when executed, cause the system to:
identify a knowledge transfer plan for transferring knowledge from a first person to a second person, wherein the knowledge transfer plan is associated with a topic;
identify a meeting between the first person and the second person to transfer knowledge therebetween;
generate, using a large language model, a summary of the meeting;
access data from an external source that is related to the topic of the knowledge transfer plan; and
aggregate, using the large language model, the summary of the meeting and the data from an external source into the knowledge transfer plan.

17. The system of claim 16, wherein the large language model returns an aggregated summary that includes the summary of the meeting and the data from the external source.

18. The system of claim 16, wherein the instructions, when executed, further cause the system to submit a prompt to the large language model to obtain an answer associated with the prompt.

19. The system of claim 18, wherein the prompt is associated with a question about at least one of knowledge transfer meetings, knowledge transfer plans, or knowledge transfer plan status.

20. The system of claim 16, wherein the instructions, when executed, further cause the system to:
identify a meeting transcript;
break the meeting transcript into a plurality of smaller chunks;
prompt the large language model to extract relevant information from each of the plurality of smaller chunks; and
merge the extracted relevant information from each chunk into a single chunk.
